(19) United States
(12) Patent Application Publication
(10) Pub. No.: US 2008/0181797 A1
(43) Pub. Date: Jul. 31, 2008

(54) HYDRAULIC SUBMERSIBLE PUMP WITH ELECTRIC MOTOR DRIVE

(75) Inventor: Clayton Hoffarth, Breton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: GLOBAL ENERGY SERVICES LTD., Calgary (CA)

(21) Appl. No.: 11/935,341

(22) Filed: Nov. 5, 2007

(30) Foreign Application Priority Data
Jan. 26, 2007 (CA) 2576693

(51) Int. Cl. F15B 17/00

(52) U.S. Cl. 417/375

(57) ABSTRACT

A hydraulic submersible pump with electric motor drive including a master cylinder and at least one slave cylinder in axial alignment with the master cylinder, each having a piston. Each slave piston is connected by a rigid linkage to the master piston, such that movement of the master piston results in movement of each of the slave pistons. Hydraulic fluid is driven through hydraulic fluid conduits by a hydraulic pump selectively supply hydraulic fluid to and draws hydraulic fluid from different portions of the master cylinder. An intake port with a one way valve is on the at least one slave cylinder permits entry of well fluids from the well into the at least one slave cylinder via the intake port and preventing well fluids from exiting the at least one slave cylinder via the intake port. An exhaust port controlled by a one way exhaust valve is on the at least one slave cylinder adapted to be connected by conduit to surface. An electric motor drives the hydraulic pump.

### FIELD OF THE INVENTION

The present invention relates to a hydraulic submersible pump that is driven by an electric motor.

### BACKGROUND OF THE INVENTION

In high water volume applications, an electric submersible pump is preferred. However, in some pumping applications, such as coal bed methane, water volumes tend to reduce over time. Unfortunately, an electric submersible pump does not work well in low to medium flow applications.

### SUMMARY OF THE INVENTION

According to the present invention there is provided a hydraulic submersible pump with electric motor drive, comprising a master cylinder and at least one slave cylinder in axial alignment with the master cylinder. A master piston is positioned in the master cylinder, dividing the master cylinder into a first portion and a second portion. A slave piston is positioned in the at least one slave cylinder, dividing each slave cylinder into a first portion and a second portion, each slave piston being connected by a rigid linkage to the master piston, such that movement of the master piston results in movement of each of the slave pistons. A first hydraulic fluid conduit selectively supplies hydraulic fluid to and draws hydraulic fluid from the first portion of the master cylinder. A second hydraulic fluid conduit selectively supplies hydraulic fluid to and draws hydraulic fluid from the second portion of the master cylinder. An intake port is on the at least one slave cylinder, the intake port having a one way valve permitting entry of well fluids from the well into the at least one slave cylinder via the intake port and preventing well fluids from exiting the at least one slave cylinder via the intake port. An exhaust port is on the at least one slave cylinder adapted to be connected by conduit to surface, the exhaust port being controlled by a one way exhaust valve permitting fluids to exit the at least one slave cylinder via the exhaust port and preventing well fluids from the conduit to surface from flowing back into the slave cylinder. A hydraulic pump is connected to the first hydraulic fluid conduit and to the second hydraulic fluid conduit, the hydraulic pump having a switching valve having a first position where the hydraulic pump drives liquid in a first direction through the first hydraulic fluid conduit and draws fluid through the second hydraulic fluid conduit and a second position where the hydraulic pump drives liquid in a second direction through the second hydraulic fluid conduit and draws fluid through the first hydraulic fluid conduit. An electric motor drives the hydraulic pump, whereby the hydraulic pump alternatively creates a circulation into and out of the first portion and into and out of the second portion of the master cylinder to cause reciprocating pumping movement of the master piston.

The hydraulic submersible pump with electric motor drive, as described above, is able to handle low to medium flow much better than the original electric submersible pumping installation. If desired, the hydraulic submersible pump with electric motor drive can reuse many of the components from the original electric submersible pumping installation.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side view, in section, of a hydraulic submersible pump with electric motor drive with fluid flowing being drawn into the slave cylinder.

FIG. 2 is a side view, in section, of the hydraulic submersible pump of FIG. 1 with fluid flowing out of the slave cylinder.

FIG. 3 is a side view, in section, of a variation of the hydraulic submersible pump of FIG. 1.

### DETAILED DESCRIPTION OF THE PREFERRED EMBODIMENT

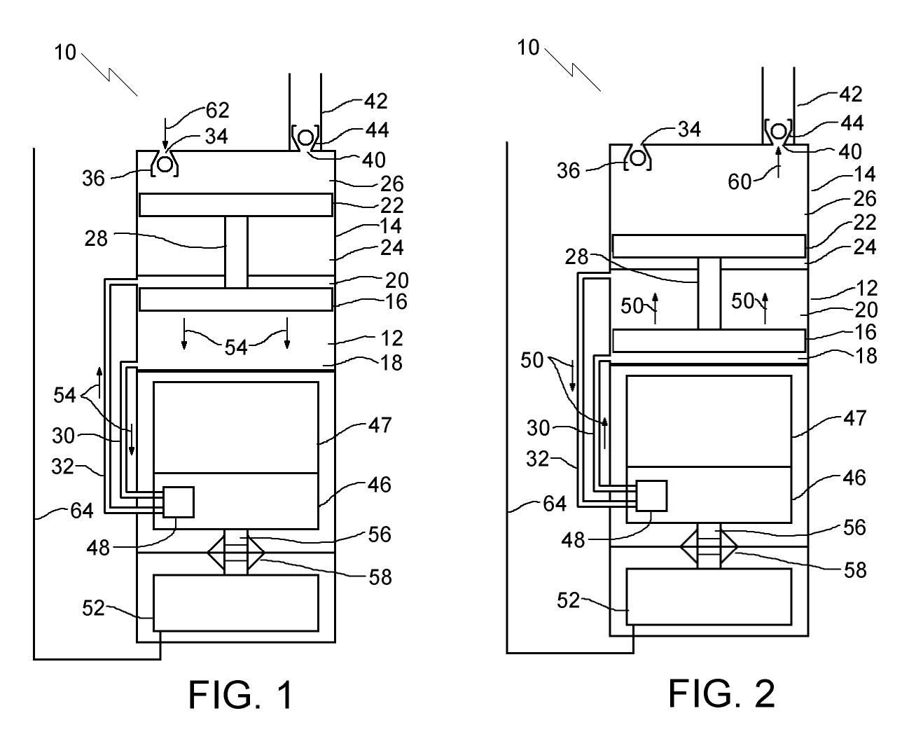

The preferred embodiment, a hydraulic submersible pump with electric motor drive generally identified by reference numeral 10, will now be described with reference to FIGS. 1 and 2.

Structure and Relationship of Parts:

Referring to FIG. 1, hydraulic submersible pump with electric motor drive 10 includes a master cylinder 12, and a slave cylinder 14 in axial alignment with master cylinder 12. A master piston 16 is positioned in master cylinder 12, which divides master cylinder 12 into a first portion 18 and a second portion 20. A slave piston 22 is positioned in slave cylinder 14, which divides slave cylinder 14 into a first portion 24 and a second portion 26. Slave piston 22 is connected to master piston 16 by a rigid linkage 28, such that movement of master piston 16 results in movement of slave piston 22. While only one slave cylinder 14 has been shown, it will be understood that more than one may be incorporated.

A first hydraulic fluid conduit 30 selectively supplies hydraulic fluid to and draws hydraulic fluid from first portion 18 of master cylinder 12. A second hydraulic fluid conduit 32 selectively supplies hydraulic fluid to and draws hydraulic fluid from second portion 20 of master cylinder 12. An intake port 34 is on slave cylinder 14 and has a one way valve 36 that permits entry of well fluids from the well into slave cylinder 14 via intake port 34 and prevents well fluids from exiting slave cylinder 14 via intake port 34. An exhaust port 40 is on slave cylinder 14 and is adapted to be connected by conduit 42 to the surface. Exhaust port 40 is controlled by a one way exhaust valve 44 that permits fluids to exit slave cylinder 14 via exhaust port 40 and prevents well fluids from conduit 42 to the surface from flowing back into slave cylinder 14 while valves 36 and 44 have been depicted as ball and cage valves, it will be understood that other one way valves could be substituted.

A hydraulic pump 46 is connected to first hydraulic fluid conduit 30 and to second hydraulic fluid conduit 32, and has a hydraulic reservoir 47. Hydraulic pump 46 has a switching valve 48 having a first position which affects flow as shown in FIG. 2 and a second position which affects flow as shown in FIG. 1. Different arrangements for switching valve 48 will be apparent to those skilled in the art. An electric motor 52 drives hydraulic pump 46, whereby hydraulic pump 46 alternatively creates a circulation into and out of the first portion 18 and into and out of second portion 20 of master cylinder 12 to cause reciprocating pumping movement of master piston 16. Electric motor 52 is connected to hydraulic pump 46 by a shaft 56, which is sealed by a seal 58, and receives power through cord 64.

Operation:

Referring to FIG. 1, hydraulic submersible pump with electric motor drive 10 is provided as described above, and is positioned in a well (not shown). As electric motor 52 drives hydraulic pump 46, hydraulic pump 46 alternatively creates a circulation into and out of the first portion 18 and into and out of second portion 20 of master cylinder 12 to cause reciprocating pumping movement of master piston 16, as switching valve 48 switches between a first position and a second position. In the second position shown in FIG. 1, hydraulic fluid is driven in a first direction into second portion 20 of master cylinder 12 and drawn from first portion 18 of master cylinder 12 as represented by arrows 54, causing master piston 16 to descend, which, by means of rigid linkage 28, causes slave piston 22 to descend as well. As slave piston 22 descends, well fluids are drawn into second portion 26 of slave cylinder 14 through intake port 34, as represented by arrow 62. Switching valve 48 then switches to the first position, such that, referring to FIG. 2, hydraulic fluid is driven in a second direction into first portion 18 and drawn from second portion 20 as represented by arrows 50, causing master piston 16 and therefore slave piston 22 to rise. As slave piston 22 rises, well fluids are expelled from second portion 26 through exhaust port 40 such that they travel through conduit 42 to the surface.

It will be understood that the above operation is for one embodiment only. For example, ports 34 and 40 could also be connected to first portion 24, such that fluids would be drawn in as slave piston 22 travels upward, and expelled as slave piston 22 descends.

Variation:

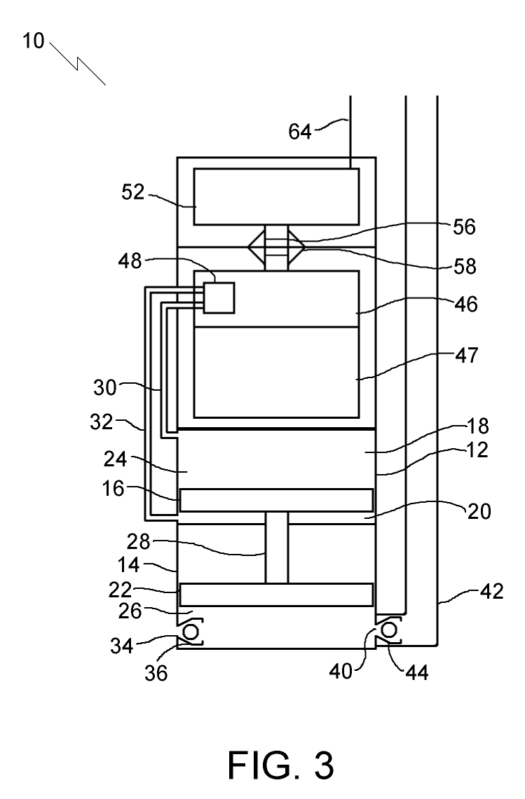

The arrangement of hydraulic submersible pump 10 described above is not the only possible configuration. For example, referring to FIG. 3, electric motor 52 is above master cylinder 12, slave cylinder 14, and hydraulic pump 46. Other arrangements are also possible besides those depicted, such as placing electric motor 52 between hydraulic pump 46 and master cylinder 12, or placing slave cylinder 14 between hydraulic pump 46 and master cylinder 12. However, each of these would require unnecessary lengthening of fluid conduits 30 and 32.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A hydraulic submersible pump with electric motor drive, comprising:
a master cylinder;
at least one slave cylinder in axial alignment with the master cylinder;
a master piston positioned in the master cylinder, dividing the master cylinder into a first portion and a second portion;
a slave piston positioned in the at least one slave cylinder, dividing each slave cylinder into a first portion and a second portion, each slave piston being connected by a rigid linkage to the master piston, such that movement of the master piston results in movement of each of the slave pistons;
a first hydraulic fluid conduit selectively supplying hydraulic fluid to and drawing hydraulic fluid from the first portion of the master cylinder;
a second hydraulic fluid conduit selectively supplying hydraulic fluid to and drawing hydraulic fluid from the second portion of the master cylinder;
an intake port on the at least one slave cylinder, the intake port having a one way valve permitting entry of well fluids from the well into the at least one slave cylinder via the intake port and preventing well fluids from exiting the at least one slave cylinder via the intake port;
an exhaust port on the at least one slave cylinder adapted to be connected by conduit to surface, the exhaust port being controlled by a one way exhaust valve permitting fluids to exit the at least one slave cylinder via the exhaust port and preventing well fluids from the conduit to surface from flowing back into the slave cylinder;
a hydraulic pump connected to the first hydraulic fluid conduit and to the second hydraulic fluid conduit, the hydraulic pump having a switching valve having a first position where the hydraulic pump drives liquid in a first direction through the first hydraulic fluid conduit and draws fluid through the second hydraulic fluid conduit and a second position where the hydraulic pump drives liquid in a second direction through the second hydraulic fluid conduit and draws fluid through the first hydraulic fluid conduit; and
an electric motor for driving the hydraulic pump, whereby the hydraulic pump alternatively creates a circulation into and out of the first portion and into and out of the second portion of the master cylinder to cause reciprocating pumping movement of the master piston.
